(19) United States
(12) Patent Application Publication
(10) Pub. No.: US 2010/0268716 A1
(43) Pub. Date: Oct. 21, 2010

(54) SYSTEM AND METHODS OF PROVIDING INTERACTIVE EXPERTIZED COMMUNICATIONS RESPONSES USING SINGLE AND MULTI-CHANNEL SITE-SPECIFIC INTEGRATION

(76) Inventors: Fabien G. Degaugue, San Francisco, CA (US); Jai H. Choi, San Francisco, CA (US); Daren A. Race, San Francisco, CA (US); Nileshwar Dosooye, San Francisco, CA (US)

Correspondence Address: GERALD B ROSENBERG;NEW TECH LAW, 260 SHERIDAN AVENUE, SUITE 208, PALO ALTO, CA, 94306-2009, US

(21) Appl. No.: 12/762,209

(22) Filed: Apr. 16, 2010

Related U.S. Application Data
(60) Provisional application No. 61/170,459, filed on Apr. 17, 2009.

(51) Int. Cl. G06F 15/16; G06F 17/30

(52) U.S. Cl. 707/741; 707/780; 709/224; 707/E17.014; 707/802; 707/E17.005; 707/769; 707/E17.002

(57) ABSTRACT

A real-time search system enables askers to identify and submit questions to topically and skill level relevant potential answerers. A computer server receives and analyzes short text questions, determines a corresponding set of informational facets semantically and topically characterizing the question. The informational facets are evaluated against a database index of informational facets identified from prior analyzed messages correlated by profile identifiers of message originators to provide an identification of a plurality of potential answerers. The question is distributed to the plurality of potential answerers and ensuing message conversations between the asker responsive answerers are monitored for quality and sufficiency of response. The stored profiles of responsive answerers are updated to reflect the occurrence and quality of response.

This application claims the benefit of U.S. Provisional Application No. 61/170,459, filed Apr. 17, 2009.

### BACKGROUND OF THE INVENTION

1. Field of the Invention

The present invention is generally related to information management systems and, in particular, to computer-based system providing for the management of interactive, expertized communications through one or more communications channels.

2. Description of the Related Art

With the maturation of the Internet and other electronic-based communications systems, usage of largely text-oriented communications services have gained in substantial popularity. Definitive categorization of currently available services is difficult, as the available features overlap widely, both by degree and in kind. In general, these services have been distinguished more on the basis of intended audience presentation rather than technical aspects. As such, many communications services can be categorized variously as on-line journals, social networks, and chat services. In most cases, the communications service is associated with a particular network site, or domain, used for administrative services if not also as the primary client interface for the communications service. Where a primary site is not used, a channel specific communications protocol, and associated client, is typically employed.

Examples of on-line journals include blogs, electronic newspapers, portals, Rich Site Summary (RSS) website concentrators. These communications services are typically sourced by individuals, small groups or aggregated from these entities. These communications services are essentially broadcast oriented typically through presentation of pages within a corresponding site specific domain.

Examples of social-networks include Facebook, OpenSocial, MySpace, LinkedIn, and Friendster. To different degrees, these sites focus primarily on directed communications between known individuals and groups, while further supporting unaffiliated individuals to follow or join as acquaintances. Communications are generally directed between individuals or an individual, defined groups, and acquaintances. The social-networking systems are, again, generally restricted to site-specific domains.

Chat services characteristically operate to enable conversations between individuals. Examples of conventional chat systems include Google gtalk, the meebo chat client (Meebo, Inc.), Microsoft Messenger, Ebay Skype, AOL Instant Messenger (AIM) and short message service (“SMS”) text message systems. Systems that start with an initial broadcast message, but tend to resolve to a conversation between individuals, are also often considered chat systems. Examples include micro-blogging services, such as Twitter, and the older style Internet relay chat (IRC) and news group services, such as Google groups.

In all, the various communications services tend to be essentially isolated to discrete communications channels. Although clients for the various channels may exist for different platforms, such as personal computers and cellular telephones, current clients are dedicated to particular site-specific or, equivalently, protocol-specific, channels.

The use of the various site-specific communications services have grown in large part to the long reach and immediacy of communications with essentially no limit on the nature of the information that can be shared. Any question can be asked and answered within the nature of the communications channel used. Blog entries and articles in electronic newsletters are responded to by the posting of comments. Questions can be posted to social-network acquaintances and answers discussed. The chat services allow specific questions to be asked of selected individuals or groups. Although questions may be asked, an inherent problem exists in determining the correctness of any answers received. This problem is particularly significant where the communications channel provides some degree of anonymity for those who provide answers.

Consequently, a number of service providers have identified a market to provide answers of qualified reliability. For example, WikiAnswers, Yahoo!Answers, and others utilize an ad-hoc peer-review system to establish the reliability of answers to presented questions. Others, such as ChaCha and ExpertsExchange utilize service provider designated experts to provide answers to direct questions. For these, the reliability of the response is premised simply on the reputation of the service provider.

In many cases, the quality of the response remains poorly defined, given that the quality of peer-review or of any given so-called expert may be limited. Furthermore, the reputation of the answerer may be completely unknown or hidden from the asker. Thus, where a question is asked of known individuals, none may be qualified to provide a reliable answer. Where a question is asked of a larger, essentially anonymous group, the asker is left with the difficult problem of distinguishing both the currency and correctness of whatever answer is received.

### SUMMARY OF THE INVENTION

Thus, a general purpose of the present invention is to provide an efficient system enabling the organization and provision of expertized responses to directed inquiries over site-specific communications channels. The system operates to broadly identify relevant experts based on current knowledge, and provide reputation information to askers to assist in determining the quality and reliability of the answers received. In alternate embodiments, support is provided for multiple channels, including optionally cross-channel use.

This is achieved in the present invention by providing a real-time search system that enables askers to identify and submit questions to topically and skill level relevant potential answerers. A computer server receives and analyzes short text questions, determines a corresponding set of informational facets semantically and topically characterizing the question. The informational facets are evaluated against a database index of informational facets identified from prior analyzed messages correlated by profile identifiers of message originators to provide an identification of a plurality of potential answerers. The question is distributed to the plurality of potential answerers and ensuing message conversations between the asker responsive answerers are monitored for quality and sufficiency of response. The stored profiles of responsive answerers are updated to reflect the occurrence and quality of response.

An advantage of the present invention is that it enables askers to acquire human intelligent answers in essentially real-time. The system implementing the present invention operates to identify multiple potential answerers with current, topic specific expertise, present the question, and monitor for success as defined by the asker receiving an acceptable answer. The question may be submitted to additional potential answerers in a progression where prior identified answers do not respond or respond with non-accepted answers. Typically, the system achieves a very low latency to receive answers to posted questions and a high closure rate of answer acceptance.

Another advantage of the present invention is that, for a given question, the potential answerers are selected based on the actual content of the question presented. The system implementing the present invention does not require pre-categorization of the nature of the question. Rather, a context is discerned primarily from the question itself with, optionally, additional context inferred from a background profile of the asker, prior questions submitted by the asker, the source Web page on which the question was asked, and current events, such as current topical news stories. Potential answerers are matched to the question based on inferred recent knowledge applicable to the topic and discernable context of the question. Optionally, though preferably, profiles of the potential answers are considered where the profiles are informed from the prior comments, remarks, and questions generally provided by the answerer as well as the nature and acceptance quality of answers provided in response to previous questions presented through the present system. Accordingly, the potential answerers are particularly matched as appropriate to handle a given question regardless of the nature of the question. The system implementing the present invention is fully capable of fielding questions spanning the purely technical, or fact oriented, to those that involve purely social and emotional issues.

A further advantage of the present invention is that the implementing system preferably operates continuously to gather information useful in identifying potential answerers. The continuous data gathering enables new potential answerers to be dynamically identified and engaged without requiring pre-registration. The continuous data gathering also enables ongoing evaluation of the knowledge and interest areas of potential answers as well as actual patterns of availability for participation as an answerer. In accordance with the present invention, anyone who participates in the communications stream of a monitored channel is a potential answerer. This enables the system to identify and leverage current, evolving expertise of potentially millions of answerers and then match these potential answerers to questions with a high degree of substantive accuracy even where the underlying information required for answering a particular question is continuously evolving or otherwise subject to change.

Still another advantage of the present invention is that the system enables the asker and answerer to engage in a chat session as necessary to refine the question and explain a potential answer. The conversational exchange also enables immediate evaluation of the quality of the answerer and reliability of the preferred answer while generally maintaining a level of anonymity between the asker and answerer.

Yet another advantage of the present invention is that askers can utilize using one point of access for presentation of the question, utilizing as appropriate clients implemented for ubiquitous communications platforms to access currently relevant answerers and have a high-confidence in the quality of the response. Optionally, the system implementing the present invention can operate as a bridge among multiple site-specific communications channels as needed and appropriate to interact with the most relevant matched answers for a give question. That is, using a system implementing the present invention, the asker can effectively leverage multiple popular communications channels and social networks as desirable to obtain an acceptable answer.

### BRIEF DESCRIPTION OF THE DRAWINGS

These and other advantages and features of the present invention will become better understood upon consideration of the following detailed description of the invention when considered in connection with the accompanying drawings, in which like reference numerals designate like parts throughout the figures thereof, and wherein:

FIG. 1A is a system architecture diagram illustrating a preferred embodiment of the present invention.

FIG. 1B is a system diagram illustrating a preferred operating environment for a preferred embodiment of the present invention.

FIG. 2 provides a diagram illustrating an optional modification of the system architecture enabling bridging of multiple site-specific and channel-specific communications channels.

FIG. 3 is a flow diagram illustrating a preferred mode of question and answer operation as implemented in a preferred embodiment of the present invention.

FIG. 4 is a flow diagram illustrating a preferred mode of real-time conversation monitoring and data acquisition as implemented in a preferred embodiment of the present invention.

FIG. 5 is a detailed flow diagram illustrating a preferred embodiment of the topic and context evaluation algorithm as utilized in question analysis and real-time data acquisition processing as implemented in accordance with the present invention.

### DETAILED DESCRIPTION OF THE INVENTION

### System Architecture

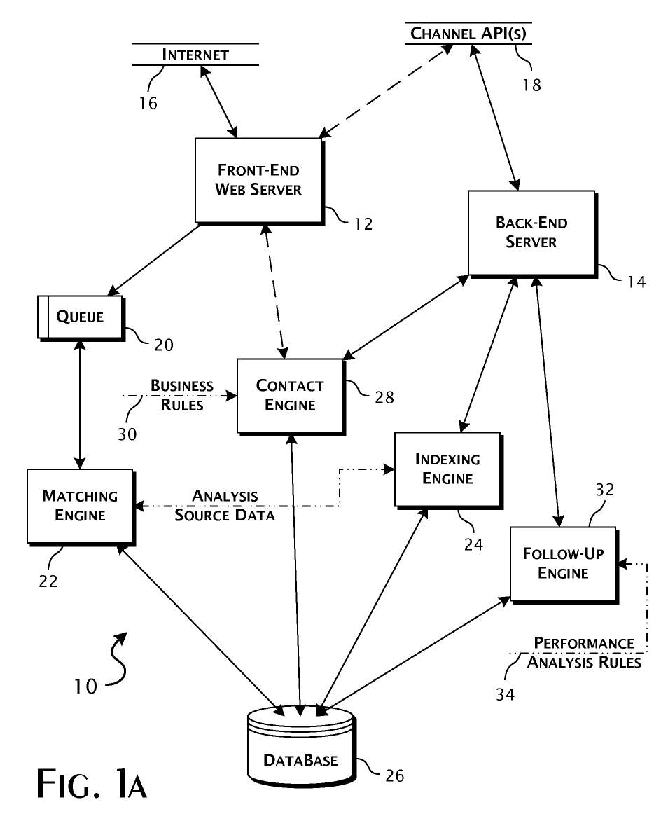

The preferred embodiments of the present invention utilize a multi-tier computer system to support the ongoing service operations required to implement control and data processing operations in accordance with the present invention. Referring to FIG. 1A, a preferred system architecture 10 is provided to illustrate the logical service operations implemented in an initial preferred embodiment. The front-end Web server 12 is initially implemented on a single physical server and operates to provide a Web site interface for local site-specific user interoperation. Variant Web site interfaces, such as appropriate for mobile browsers, and other client applications are supported through the front-end Web server 12. In the preferred embodiments of the present invention, the front-end Web server 12 is preferably implemented using an Apache HTTP Server. Depending on demand, multiple physical servers may be used in a load-balanced configuration to logically implement the front-end Web server 12. The remaining elements of the system architecture 10 are preferably implemented in an initial embodiment on a back-end server 14 utilizing a single physical or virtualized server performing both control and database access operations.

The front and back-end servers 12, 14 preferably have access to a public communications network 16, such as the Internet, or, where implemented for a dedicated information entity, such as a corporation, to a private intranet. The communications network 16 is preferably used by the front-end Web server 12 to provide access to the Web site interface principally for end-users to present questions, to review archived prior answered questions, and to receive ongoing updates and background information on answerers matched to submitted questions.

Both the front and back-end servers 12, 14 preferably also utilize the communications network 16 to access typically public channel application program interfaces (APIs) 18 made available over the communications network 16 by third-parties. These channel APIs are typically implemented utilizing some combination of third-party site-specific APIs and standardized communications protocols. In the initial embodiments of the present invention, the primary site-specific API utilized is the REST-protocol accessed API (apiwiki.twitter.com) published and made publically available by Twitter, Inc. Other site-specific APIs, such as the API hosted by Facebook, Inc., and generalized channel-specific protocols, such as the IRC and NNTP protocols, can be used and accessed in combination by embodiments of the present invention.

A preferred operating environment 40 is generally illustrated in FIG. 1B. The front-end Web server 12 makes the Web site interface accessible through the communications network 16, 18 to various, typically end-user systems 42, 44. The back-end server 18 utilizes the communications network 16, 18 to access the site-specific APIs and utilize channel-specific protocols of remote third-party systems 46. Preferably, the back-end server 18 accesses the third-party systems 46 to monitor typically end-user communications routed through or otherwise facilitated by the third-party systems 46, to receive data streams and messages published through those systems 46, and to post or otherwise send communications streams and messages to those third-party systems 46, directly or indirectly. The front-end server 12 may also utilize the site-specific APIs and channel-specific protocols to connect with various client applications that, at least natively, may access the front-end server 12 through any of the channel APIs and protocols.

Referring again to FIG. 1A, an input queue 20 is provided as a buffer holding questions received by the front-end server 12. In the initial preferred embodiments, an individual question presented by an end-user will typically be a short statement or sentence typically no longer than a few hundred characters in length, or ten to twenty words in total. The input queue 20 allows questions received by the front-end server 12 to be passed to a matching engine 22 used to identify potential answerers. The matching engine 22 preferably executes as a background process on the back-end server 14. As demand increases, multiple instances of the matching engine 22, potentially executing on multiple logical or physical servers, may be utilized to minimize the latency of any question pending in the queue 20.

In the preferred embodiments, each matching engine 22 instance operates to analyze a presented question to infer multiple information facets that are, in turn, used to select a ranked set of potential answerers. Both question analysis and the corresponding match selection of potential answerers is based, in part, on analysis source data acquired by the back-end server 14 and processed through an indexing engine 24, also preferably executed as a background process on the back-end server 14, scaling to execute on additional logical and physical server systems. Details of the question analysis, match selection, and indexing processes will be discussed in below.

In summary, the question analysis operates to infer informational facets including topic and context based on the direct content of the question text, derived associations determined from available biographical information about the asker including the demographic background of the asker, the origin of the question, for example the geographic location of the asker, any location referenced by the message text, and when submitted from or in reference to a news or product Web page the associated news and product reference by the page, and prior conversations streams and messages acquired through the channel APIs 16, 18 and correlated by the indexing engine 24. The analysis product of the indexing engine 24 is stored to a database 26 commonly accessible by the matching engine 22.

Once the significant informational facets are inferred from the question and derived associations, the matching engine 22 performs a search for potential answerers with inferred current expertise or similar interests corresponding to the informational facets of the question and, further, that are inferred to be currently available remotely through the channel APIs for involvement in potentially answering the question as presented. Multiple sources of information can be and, preferably, are considered in performing the match search. A first source is archived prior questions and answers processed through the present system. The content of these conversations are analyzed to determine informational facets that, in turn, can be correlated with the question to determine a match ranking. These rankings are further correlated with at least the addressable on-line identity of the participants and, therefore, of potential answerers for the present question.

Another source is recent conversations, retrieved either by real-time searches through the channel APIs 16, 18 or directly from the database 26 as prior captured through the ongoing operation of the indexing engine 24, can be similarly used to rank and identify potential answers. The real-time searches are preferably performed by constructing channel API queries based on the inferred informational facets of the present question. Matching result set conversations are then analyzed and potential answerers identified. In alternate embodiments of the present invention, the back-end server 14 and indexing engine 24 operate, in real-time, to accumulate a searchable historical record of the conversations and messages available through the channel APIs. These conversations can be preliminarily analyzed, compressed and stored to the database 26 for subsequent searching by the matching engine 22.

A third source is the explicit and inferred profiles of end-users who participate as potential answerers. In an alternate embodiment of the present invention, explicit profiles can be setup and maintained by self-selected volunteer answerers. These profiles can collect information about the knowledge and interests of the answerers sufficient to provide a basis for inferring matchable informational facets, preferably including ontologically significant key words and phrases identifying self declared areas of expertise, biographical and resume texts, and links to associated Web pages. Inferred profiles are constructed and informed by operation of the indexing engine 24 based on an ongoing analysis of conversations received through the channel APIs. Once an empirically determined sufficient number of messages can be associated with a potential answerer, the profile is constructed and populated with informational facets that identify potential areas of expertise, biographical aspects and interests, location, and other details as determinable from the content of the messages. Both explicit and inferred profiles are progressively updated based on inferred informational facets determined and aggregated from the ongoing message stream further correlated to the addressable on-line identity of the participants. In addition, time-stamps of the messages participating in identifiable conversations are analyzed to infer a schedule of likely on-line availability by the potential answerer. These profile data sets are stored to the database 26 for subsequent consideration by the matching engine 22.

A fourth source is the direct or inferred origin of the question. In accordance with the present invention, third-party Web pages may be augmented with a question form that enables an end user to directly submit questions to the server of the present invention. Augmentation can be by direct embedding of a question form into the Web page or provided by a browser plugin or service-specific toolbar. On submission of the form, key elements of the Web page may be encoded with the submitted question to identify, for example, a particular product, news story, current event, or identified individual or entity that is the principal subject discussed on the Web page. Alternately, the URL of the Web page may be submitted with the question to enable the server 14 of the present invention to subsequently retrieve and digest the content of the page as appropriate to infer a context associated with the question. In addition to any inferred origin Web page context, and particularly where the origin page provides no meaningful context, the present invention may infer context from the occurrence of events in real-time observed directly from the flow of messages through the communications channels 16, 18 and, optionally, by directly monitoring various news, weather, and other real-time sources of information generally accessible through the communications network 16, 18.

Once the matching engine 22 has produced a ranked list of potential answerers, the question, preferably including the inferred informational facets, and the ranked list of potential answerers are initially stored to the database 26. In the initially preferred embodiments of the present invention, the ranked list of potential answerers identifies approximately fifteen individuals suitable for answering the question.

Preferably in response to an event sent by a matching engine 22, such as by operation of a database trigger, or produced by a periodic scheduling function, a contact engine 28 will query the database 26 for available questions to be posted. The contact engine 28 preferably operates to consider the ranked potential answerers and pick a subset of defined size for immediate receipt of the question. In the preferred embodiments of the present invention, the contact engine 28 operates over a defined set of business rules 30 that constrain the selection of potential answers based on factors including likelihood of current availability, time since last availability, frequency of questions presented, frequency of response to questions presented, quality of responses, latency of responses, length of responsive conversation, relative match rank to the question, preferred channel and language, and others. In the preferred embodiments of the present invention, the business rules 30 are either stored and retrieved from the database 26 or informed by qualifying business rule data stored and retrieved from the database 26. Based on a weighted evaluation of these business rules 30, the contact engine 28 selects an initial set for presentation of the question for response.

In the initial preferred embodiments, the target size of the initial set of potential answerers is empirically set at five. Once identified, the contact engine 28 utilizes the back-end server 14 to forward copies of the question directly or indirectly to the potential answers. In an alternate embodiment of the present invention, the contact engine 28 may augment the question to provide the potential answerer with information about the inferred context of the question, such as the name of a person, product, event, or other details, inferred as contextually relevant from the origin Web page, real-time current events, or the asker's prior questions or public biographical background. This augmentation may be performed through addition of a URL link into the body of the question. Preferably, the URL link will reference a dynamically composed Web page that contains this contextual information. Another alternative is for the contact engine to create and send one or more supplemental messages to the potential answerers who have received the asker's question as an immediate follow-up to provide the contextual information directly or by presentation of the URL link separate from the body of the question.

In the initial preferred embodiments, the contact engine 28 monitors the relevant communications streams for question responsive messages from the potential answers to gauge whether an adequate number of potential answers are being offered to the asker within an empirically defined period of time. In general, one or two replies from potential answerers are considered adequate. Where an inadequate number of replies occur, the contact engine 28 reevaluates the list of potential answerers and selects an additional set potential answerers to receive copies of the question. A business rule 30 will define the total number of question forwarding iterations and the number of potential answerers that will be presented with the question. When the threshold determined by the business rule 30 is reached, the questioning process will be terminated. The question may then be marked as unanswered.

Finally, a follow-up engine 32 operates to evaluate the quality of response, including correlated conversations. The follow-up engine 32 monitors the conversation streams and messages received through the channel APIs 16, 18 to identify likely responses to specific presented questions. Relevant data is collected and stored to the database 26, including the on-line identity of the answerer, individual response time, average response time, number of answerers who reply, length of ensuing conversation, the analyzed relevance of the provided response relative to the question, analyzed appearance of satisfaction by the asker. The follow-up engine 32 also examines the conversation streams and messages for indications of abuse or misuse of the system implementing the present invention. The selection and analysis of data is preferably informed and controlled by a defined set of performance analysis rules 34. In the preferred embodiments of the present invention, the performance analysis rules 34 are either stored and retrieved from the database 26 or informed by qualifying performance analysis rule data stored and retrieved from the database 26. With collection of sufficient historical data, statistical analyses are preferably employed to calculate a current presence indicator, a likelihood of response estimator, average response time, channel preferences, and level of interest estimates correlated to different informational facets. All of the data collected and produced are preferably used to refine and extend the corresponding inferred profiles of answerers as stored by the database 26.

In addition, the follow-up engine 32 preferably operates to collect and store question and answer message threads to the database 26. These conversations are then preferably published through the front-end Web-server 12. Permalinks are provided to allow external search engine indexing. End users may optionally reopen or refer to the conversations in asking new questions. Preferably, the front-end Web server 12 will support end-user subscription to identified conversations, and provide notices whenever the conversation is reopened or referenced.

Bridge System Architecture

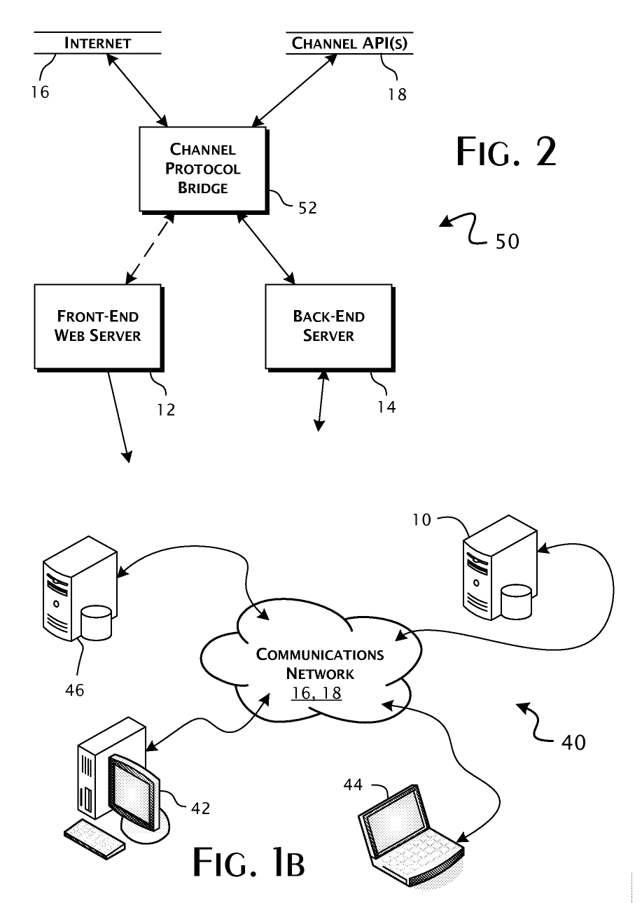

Referring to FIG. 2, a modified system architecture 50 can be implemented by adding proxy and cross-channel support to the system 10 as described above. A channel protocol bridge 52 can be implemented on a separate physical server or logically on both the front and back-end servers, 12, 14. The channel protocol bridge 52 preferably operates to enable conversations between an asker and one or more answerers routed exclusively through the bridge 52. Rather than providing the asker's direct on-line address to potential answerers in conjunction with forwarded questions, the bridge 52 network interface is identified as the response address. In this manner, the channel protocol bridge 52 can provide a number of new capabilities, including the implementation of a cross-connect between otherwise different channels 16, 18 used to communicate with the asker and answerer, control anonymity between the asker and answer to a level higher than otherwise permitted by the channel API 16, 18, and ensure recognition of conversations that ensue from the presentation of a question to potential answerers, better recognize and more seamlessly request and receive quality evaluations independently from both the asker and answerer without revealing the opinions given to the other party.

Question & Answer Process

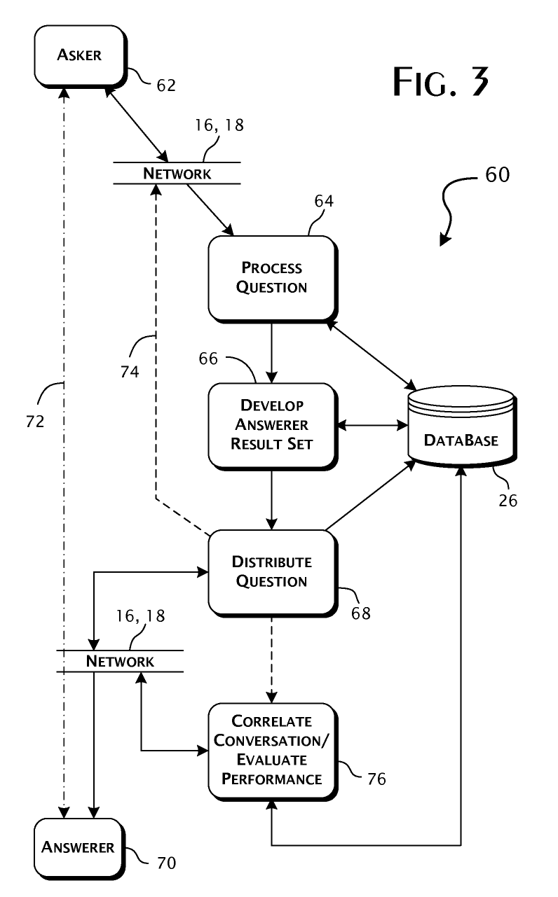

An initially preferred process 60 of obtaining reliable responses to questions is generally illustrated in FIG. 3. The preferred front-end Web server 12 presents a site specific Web page form for soliciting questions from end-users. An individual Asker 62 prepares a short statement or sentence generally in the form of a question and submits the form. The question is then processed 64 by the preferred system and, by reference to the information stored by the database 26, operates to infer informational facets from the question text. These informational facets are then evaluated 66 through a matching process against the stored profile correlated informational facets of potential answerers to, in turn, infer a match ranked set of potential answerers most closely correlatable to the information facets of the question.

In the presently preferred embodiment of the present invention a result set of approximately fifteen potential answerers is identified. The original question presented by the Asker 62 is then distributed 68, using an appropriate channel API 16, 18, to a progressive subset of the determined result set. The determined need for progressive iterations is based on whether the system 10, preferably the contact engine 28, detects any relevant messages being exchanged between the Asker 62 and some corresponding Answerer 70. A minimal identification of a relevant response can be determined by observing whether a potential Answerer 70, after being forwarded a copy of the question, generates a message that is either directed to the Asker 62 or is analytically related to the original question.

In the initially preferred embodiment, the forwarded question is presented to potential Answerers 70 as if addressed and sourced from the original Asker 62. Alternately, each copy of the question is forwarded to and through the Asker 62, optionally subject to confirmation by the Asker 62 before being forwarded to the individual potential Answerers 70. In both cases, direct conversations 72 can then proceed between the Asker 62 and each individual Answerer 70. Depending on the particular channel used, the Answerers 70 may be able to see and comment on responses provided by other Answerers 70.

Optionally, as each copy of the question is forwarded, the on-line identity and relevant profile background of the potential Answerers 70 are updated 74 to a question result page presented to the end-user in response to the submission of the question form. This information will support the asker in determining whether to further respond to messages received from any particular answerer as well as qualify the reliability of any response received.

Finally, the system performs a conversation analysis and performance evaluation 76 for the purpose of collecting conversations for archival usage, collecting metrics regarding the frequency and latency of responses provided by Answerers 70, evaluating the sequence of messages to gauge the satisfaction on the part of the Asker 62 with the responses from individual Answerers 70, and to infer the level of current topical knowledge and interests of Answerers 70 for updating corresponding answerer profiles. Additionally, the conversations are monitored for signs of abuse by Askers 62 and Answerers 70, with inferred reputational information being updated to the corresponding profiles as stored in the database 26. Preferably, this portion of the process 60 is implemented by the follow-up engine 32 either in response to the distribution of a new question or at relatively frequent, periodic intervals as may be appropriate to limit unnecessary overhead load on the back-end server 14 and channel APIs 16, 18.

The conversation analysis aspect 76 also preferably operates to update individual Answerer 70 profiles with a time-correlated presence estimator, a time-correlated likelihood of response estimator, the number of questions presented within a defined trailing time period, the average rate of response to recently presented questions, average response time, inferred quality of response optionally correlated to informational facets, length of conversation per Asker 62 question, inferred correlation of provided answers to the questions presented, and inferred channel preferences. An applicable subset of this information is also updated to the Answerer 70 profile of the Asker 62. Other information may also be collected.

Preferably, the performance evaluation aspect 76 operates to collect other information, including number of questions presented to each Answerer per day and per Asker, number of initial and total Answerers presented with a question optionally correlated to informational facets, rate of response by initial and total answerers, also optionally correlated to informational facets, A/B differential testing of Answerer preferences, such as response rate by time of day and channel preference, and rate of explicit registration following contact as a potential answerer. Performance evaluation can preferably involve issuance of messages to request comments on the quality and value of the service, and evaluation of particular Askers and Answerers.

Conversation Monitor and Data Acquisition

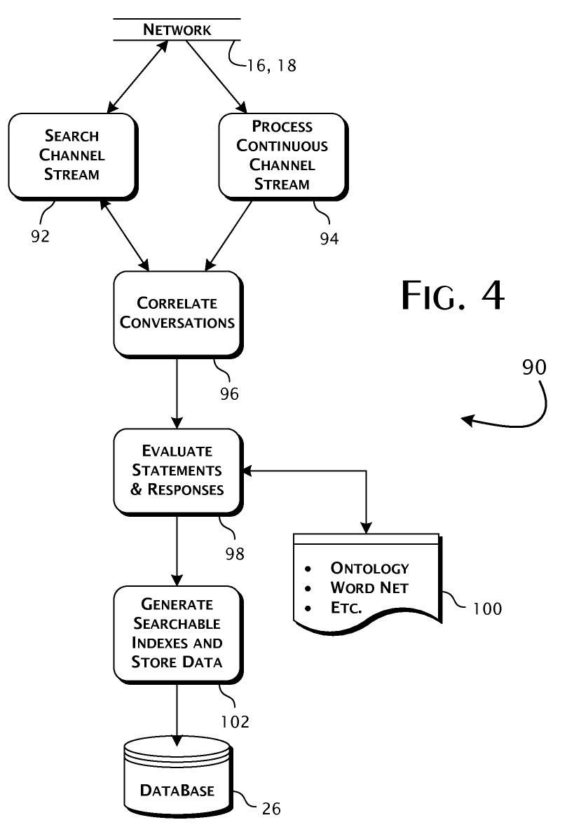

A preferred process 90 for conversation monitoring and data acquisition, as implemented in a preferred embodiment of the present invention, is shown in FIG. 4. In accordance with the present invention, the system operates to monitor the relevant ongoing conversations and messages accessible though the communications network including channel APIs 16, 18. Depending on available system and network resources, as well as details of the individual site-specific channel APIs, a combination of structured searches 92 and continuous receipt 94 is utilized to capture messages. Specifically, Twitter and Facebook messages are periodically queried for using the public channel APIs. Subscription style message feeds are continuously monitored. Typically, the resulting communications stream will provide messages in a time/channel-ordered, but otherwise unordered stream of messages. The system of the present invention operates to correlate 96 individual communications based on a combination of time-order, subject matter relation, message IDs, and the on-line identity of the end-users originating the messages. The result of correlation 96 is the ordered grouping of messages into conversations.

The message content is then analyzed 98 in detail to identify information facets, including topic and context, that are then used for the further inference of relative association as well as the sufficiency of an answer to any presented question. In performing this analysis 98, various structured data sources 100 may be utilized to aid in identifying significant information facets of the messages, considered individually, and in an alternate embodiment, considered as part of associated conversations. These data sources 100 preferably include established ontologies, such as the Wikipedia ontology, and lexical and semantic databases, such as the Princeton University WordNet database. The Freebase database (www.freebase.com) is used as a source of semantic synonyms, the MetaWeb database (www.metaweb.com) is leveraged for contextual identifications, the CrunchBase (www.crunchbase.com) provides product, technology, technology companies, people, and investors references, and constructed ontological databases are used to evaluate of job titles, companies, fields of commerce, celebrities and celebrity relations to events, media, and others. Once the informational facets of the messages are identified, the resulting data set is indexed and stored 102 to the database 26. Notably, the product of the message content analysis 98 is used by the matching engine 22 in support of the match ranking of potential answerers as well as by the follow-up engine 32 in support of conversation analysis and performance evaluation.

Analysis Process

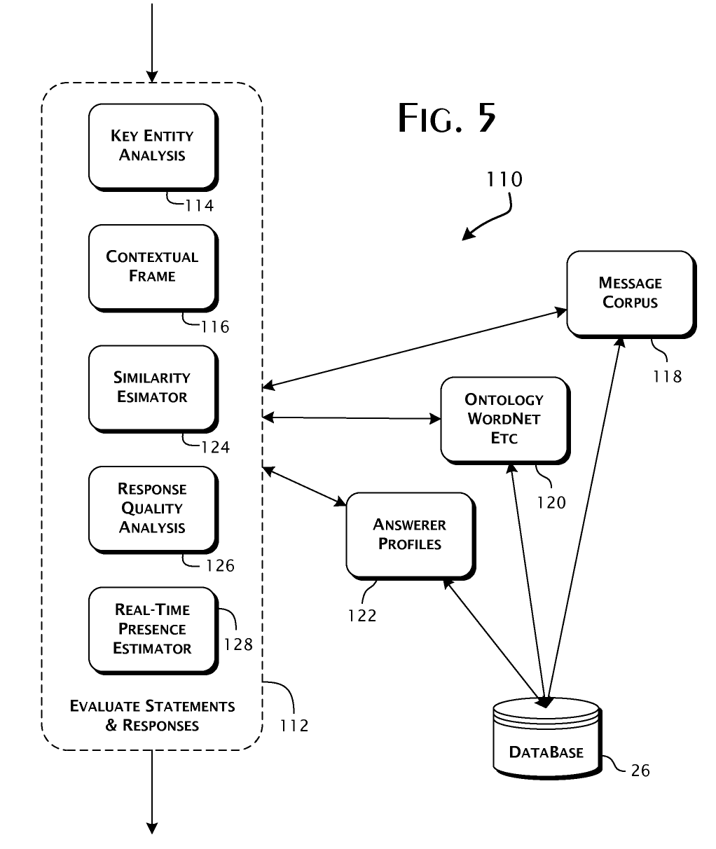

The preferred embodiments of the present invention perform a detailed analysis of the statements and potential conversational responses extracted from the sequence of communications stream messages in order to identify and qualify informational facets. Referring to FIG. 5, the analysis process 110 is preferably implemented as a dynamic pipeline 112 of analysis elements. That is, the parameters applicable to, and even selection of next pipeline processing elements, are determined at least in part by the nature and progress of processing individual messages. In summary, a first key entity processing step 114 includes stemming and N-Gram analysis to correct or reduce spelling distinctions, disambiguate jargon and acronyms, and identify potential keyword and word-phrase entities within the text of the message. For the initially preferred embodiment of the present invention, where Twitter represents the targeted communications channel, the maximum individual message is limited to 140 characters. While a short sequence of so-called tweets may be used to convey a larger or at least longer message, the present invention is capable of discerning significant informational facets from individual messages less than the single Twitter message limit.

Given a short content message, the text is initially decomposed into sentences delimited by explicit punctuation or inferred equivalences. N-Grams of length inversely proportional to the length of the sentences are then identified and collected as a sets representing the message. The individual N-Grams are then used as probes against various databases identified above, including the Wikipedia ontology, the WordNet, Freebase, MetaWeb, CrunchBase and other ontological databases collecting job titles, companies, fields of commerce, celebrities and celebrity relations to events, media, and others, for exact and approximate matches. Exact matches provide higher confidence values. Inexact matches are assigned proportionally lowered confidence values. Based on the combination of N-Gram matches detected, a topical ontology categorization, preferably as mapped onto the DMOZ categorization ontology is evaluated and defined as the dominate topic for the message. For any given text, more than one category and set of key terms is identified. A statistical clustering process is performed to identify a lowest, or most likely common set. For example, if multiple potential categorizations are identified relating to multiple explicit fields of college-level sports, the cluster reduction preferably chooses the canonical form of just ‘college sports’. For key terms identified within the N-Gram phrases, a term reduction algorithm is used to select best or at least most common term forms, while eliminating duplicate and partial duplicate forms. For example, while many variants of ‘Martin Luther King, Jr’ may occur in messages, the specific, canonical form is kept and the others discarded.

Once an initial set of key entities is identified, a semantic and keyword associative analysis 116 is performed to determine an initial contextual frame for the message. This involves a evaluation of the semantic and geo-spatial relations of the identified key entities. For example, whether a term such as burgundy is a reference to a color, location, or wine. On further processing, the analysis 116 determines from the message text additional informational facets related to and that refine the contextual frame. For example, whether the message topically relates to foreign countries or local restaurants. In the preferred embodiment of the present invention, this further processing 116 utilizes a corpus 118 constructed as the analyzed and indexed result of the processing 114, 116 of prior messages. By semantic analysis, likely principal parts-of-speech in a present message are identified. Correlation against the WordNet database and other ontologies 120 aids in identifying significant keywords and word phrase entities. Significant candidate keywords and word phrases, preferably in iteratively adjusted associative combinations, are used to search the stored corpus 118. Hit-rate is first examined to determine and, as appropriate, reinforce the identification of significant keywords and word phrases. The high-ranking keywords and word phrase entities, as well as the associative relation between the keywords and word phase entities, represent informational facets of the message text under analysis. By further correlation to an established ontology 120 and semantic aspects of the informational facets, a topic and refined context can be inferred. These features are also collected as informational facets.

The informational facets produced by message analysis 114, 116 can be supplemented, in an alternate embodiment of the present invention, using weighted correlation with the informational facets determined from prior messages originated by the same end-user, as correlated by on-line identity. Preferably, the profile 122 corresponding to the on-line entity is updated with a reference to each analyzed message processed by the present system. The weighting is preferably adjusted proportional to the time differential between messages and the relative similarity of the messages. The message and analyzed information facets are added to the corpus 118 and persisted to the database 26 for future use.

A similarity estimator is then constructed 124 by conducting another search over the corpus 118 utilizing the informational facets of the current analyzed message as the primary search terms. In accordance with the present invention, this search operates to find the most relevant matching prior analyzed messages grouped by the on-line identity of the message originators. In addition to considering correlated relevance, the similarity estimator 124 also factors in biographical, demographic and geographic correspondences as may be determined from respective message originator profiles 122. Similarities in age, stated interests and knowledge areas, and the like are weighted to boost the match ranking. Preferably, select identified relationships, such as that an Asker 62 and potential Answerer 70 have a designated friend or follower relation, are weighted to reduce the match ranking. Messages authored by the on-line identity of the current analyzed message are preferably excluded from consideration. The result set produced by the similarity estimator 124 is an initial match ranked list of potential Answerers 70.

This initial result list is then refined through response quality analysis 126 and use of a real-time presence estimator 128. Preferably, the per on-line identity rankings are adjusted based on a weighted factoring of response quality, frequency of response, and latency of response, as can be determined on examination of the individual corresponding on-line identity profiles. The real-time presence estimator 128 preferably relies on a statistical analysis of prior message originations to determine the likelihood of presence of each potential Answerer 70 at the time the question is posed by an Asker 62. A potential Answerer 70 is also qualified as present if the potential Answerer 70 is, as detectable by the back-end server 14, then actively using or monitoring a communications channel directly compatible with the Asker 62 or compatible through use of the channel protocol bridge 52. A potential Answerer 70 is also considered present if the corresponding profile provides an online contact method and the timing of the question is within a schedule of availability also provided by the profile.

In the presently preferred embodiments, the real-time presence estimator 128 preferably works by analyzing previous patterns of actual use of each communications channel as determined from the on-line identity source of individual messages. That is, instances of messages sent are correlated per individual on-line identity and time segment of when the message was sent. In the preferred embodiment, a time segment is identified against a contiguous sequence of preferably fifteen minute intervals referenced to repeating 24 and 168 hour cycles. A history of these messages sent is preferably kept in the profiles 122 corresponding to on-line identity. A time-distribution curve, with probability of error, is computed based on an averaging of time segment message counts. This time-distribution curve of a particular on-line identity represents the statistical likelihood of presence of a potential Answerer 70 at any particular time. Preferably, the individual time-distribution curves are updated in a periodic background task.

By reference to the particular time segment corresponding to when a particular question is posed the rankings of the potential answers can be further weighted as a function of likelihood of presence in that time segment. In accordance with the present invention, the resulting match ranked list identifies approximately fifteen distinct potential answerers who (1) have demonstrated knowledge and expertise most directly relevant to the informational facets of the current analyzed message, and (2) are most likely to be then present to provide an answer in real-time. In the preferred embodiment of the invention, as discussed above, this match ranked list will then be evaluated against business rules to guide the selection of potential Answerers as recipients of automatic forwarding of the Asker's question. In an alternate embodiment, the match ranked list, optionally qualified by the business rules, can be presented to an Asker for manual selection of potential Answerers to receive a forwarded copy of the question.

Thus, a system and methods for enabling the organization and provision of expertized responses to directed inquiries over site-specific communications channel has been described. While the present invention has been described particularly with reference to certain named site-specific communications services and service providers, the present invention is adaptable to others of a similar nature.

In view of the above description of the preferred embodiments of the present invention, many modifications and variations of the disclosed embodiments will be readily appreciated by those of skill in the art. It is therefore to be understood that, within the scope of the appended claims, the invention may be practiced otherwise than as specifically described above.

1. A computer implemented method of providing real-time search for topically and skill level relevant answerers for asked questions, said method comprising the steps of:
a) receiving, by a computer server through a communications network, a question message containing a short text content, wherein said question message is originated by an asker;
b) analyzing, by said computer server, said question message to establish a plurality of informational facets corresponding to and characterizing said question message; and
c) evaluating said plurality of informational facets against a database of prior analyzed messages, wherein said database is coupled to said server and wherein said database records an index of informational facets identified from said prior analyzed messages correlated by profile identifiers of message originators, wherein said informational facets include semantically significant key entities, said step of evaluating providing an identification of a plurality of potential answerers.

2. The method of claim 1 further comprising the step of distributing, by said server through said communications network, said question message to said plurality of potential answerers.

3. The method of claim 2 further comprising the steps of
a) monitoring, by said server through said communications network, an ensuing message conversation between said asker and a responsive answerer, wherein said responsive answerer is one of said plurality of potential answerers; and
b) updating a profile stored by said database with respect to said responsive answerer.

4. The method of claim 3 wherein said informational facets include an identification of a contextual frame of said question message.

5. The method of claim 4 wherein said informational facets include an ontological topic.

6. The method of claim 5 wherein said step of evaluating identifies said plurality of potential answerers based on a highest similarity estimate determined between said informational facets of said query message and said prior analyzed messages as represented by said index of informational facets.

7. The method of claim 6 wherein said step of evaluating further qualifies said plurality of potential answerers based on a real-time presence estimate relative to an origination time of said question message.

8. The method of claim 7 wherein database records origination time references for said prior analyzed messages correlated by profile identifiers and wherein said real-time presence estimate represents, based on an analysis of said origination time references, the statistical likelihood that a potential one of said potential answerers is reachable through said communications network within a predetermined time window relative to said origination time of said question message.

9. The method of claim 8 wherein said plurality of potential answerers is selected based on a combined ranking dependent on said highest similarity estimate and said real-time presence estimate.

10. The method of claim 9 wherein said step of evaluating further qualifies said plurality of potential answerers based on response quality values as stored by said database in profiles correlated to said plurality of potential answerers, and wherein said updating step analyzes said ensuing message conversations to update said response quality values with respect to said responsive answerer.

11. The method of claim 10 wherein said plurality of potential answerers is selected based on a combined ranking dependent on said highest similarity estimate, said real-time presence estimate, and said response quality values.

12. A computer system operative to provide real-time search support questions presented through network communications channels, said computer system comprising:
a) a database storing an index of informational facets and a plurality of profiles correlated to a like plurality of potential answerers, wherein said index of informational facets corresponds to a plurality of short message texts prior transferred through a communications network, and wherein said plurality of profiles are correlated to said index of informational facts based on the identities of the originators of said plurality of short message texts; and
b) a server computer system, coupled to a communications network and to said database, said server computer system being operative to receive question messages from said communications network, said server computer system including
a matching engine operative to analyze a short question message text originated by an asker with respect to said index of informational facets to identify a plurality of potential answerers;
a contact engine operative to distribute said short question message text to said plurality of potential answerers; and
a follow-up engine operative to monitor an ensuing message conversation between said asker and a responsive answerer, wherein said ensuing message conversation occurs through said communications network, and wherein said follow-up engine analyzes the short messages texts of said ensuing message conversation to determine a response quality value and aggregate said response qualify value into said profile corresponding to said responsive answerer.

13. The computer system of claim 12 further comprising an indexing engine operative to progressively receive said plurality of short message texts transferred through said communications network and update said index of informational facets, said indexing engine being further operative to record originator identities and origination time references with respect to said plurality of short message texts in said database.

14. The computer system of claim 13 wherein said indexing engine is operative to perform semantic and topical analysis of said plurality of short message texts to identify key entities within a contextual frame for each of said plurality of short message texts to produce corresponding informational facets for indexing.

15. The computer system of claim 14 wherein indexing engine is operative to access a plurality of semantic and ontological databases for retrieving data for use in performing said semantic and topical analysis.

16. The computer system of claim 15 wherein said matching engine is operative to perform semantic and topical analysis of said short question message text to identify key entities within a contextual frame for to produce corresponding question informational facets.

17. The computer system of claim 16 wherein said matching engine includes a similarity estimator operative to query said index of informational facets using said question informational facets to obtain a highest similarity estimate between said question informational facets and a subset of said index of information facets correlated to said plurality of potential answerers.

18. The computer system of claim 17 wherein said matching engine includes a real-time presence estimator operative over said origination time references to determine a statistical likelihood that a potential one of said potential answerers is reachable through said communications network within a predetermined time window relative to said origination time of said question message.

19. The computer system of claim 18 wherein said plurality of potential answerers is qualified based on a combined ranking dependent on said highest similarity estimate and said real-time presence estimate.

20. The computer system of claim 19 wherein said plurality of potential answerers is qualified based on a combined ranking dependent on said highest similarity estimate, said real-time presence estimate, and said response quality value respectively existing for said plurality of potential answerers.
